(19) United States
(12) Patent Application Publication
(10) Pub. No.: US 2021/0142995 A1
(43) Pub. Date: May 13, 2021

(54) SKIMMER CONE AND INDUCTIVELY COUPLED PLASMA MASS SPECTROMETER

(71) Applicant: SHIMADZU CORPORATION, Kyoto (JP)

(72) Inventor: Shinichi ASAHI, Kyoto (JP)

(73) Assignee: Shimadzu Corporation, Kyoto (JP)

(21) Appl. No.: 17/041,997

(22) PCT Filed: Apr. 20, 2018
(86) PCT No.: PCT/JP2018/016232

§ 371 Date: Sep. 25, 2020

(51) Int. Cl. H01J 49/04; H01J 49/10

(52) U.S. Cl. CPC H01J 49/04; H01J 49/105

(57) ABSTRACT

An inductively coupled plasma mass spectrometer 1 is provided with: an ionization unit 10 configured to ionize a sample by plasma generated from a raw material gas; a vacuum chamber partitioned into a first space 21 and a second space 22, 24, the first space 21 being maintained at a first pressure lower than atmospheric pressure, and the second space 22, 24 being maintained at a second pressure lower than the first pressure and configured to accommodate a mass separation unit 241 for performing mass separation of ions generated by the ionization unit and a detector 242 for detecting ions that have passed through the mass separation unit 241; a skimmer cone 224 arranged on a side of the first space with respect to a partition partitioning the first space 21 and the second space 22, 24, the skimmer cone 224 having a groove 224a formed on an outer peripheral surface and/or an inner circumferential surface in a circumferential direction.

### TECHNICAL FIELD

The present invention relates to a skimmer cone in which an opening is formed at a tip portion of a conical member, the skimmer cone being used in a plasma mass spectrometer or the like, and also relates to an inductively coupled plasma mass spectrometer provided with such a skimmer cone.

### BACKGROUND ART

One of the devices for analyzing elements contained in a sample is an inductively coupled plasma mass spectrometer (ICP-MS: Inductively Coupled Plasma Mass Spectrometer) (e.g., Patent Document 1). An inductively coupled plasma mass spectrometer is characterized in that a wide range of elements from lithium to uranium (excluding some elements such as rare gases) can be analyzed at the ppt (parts per trillion) level and is used to quantify heavy metal elements contained in an environmental sample, such as, e.g., seawater and river water.

FIG. 1 shows a configuration of the main part of an inductively coupled plasma mass spectrometer 100.

The inductively coupled plasma mass spectrometer 100 includes an ionization unit 110 for generating atomic ions from a sample by inductively coupled plasma and a mass spectrometry unit 130 for performing mass separation of the generated ions to detect them. The ionization unit 110 is provided with a plasma torch 112 arranged in an ionization chamber 111, which is generally at the atmospheric pressure. The plasma torch 112 is composed of a sample tube for allowing a liquid sample atomized by a nebulizer gas to pass through, a plasma gas tube formed on the outer periphery of the sample tube, and a cooling gas tube formed on the outer periphery of the plasma gas tube. In the ionization unit 110, the liquid sample sprayed from the sample tube is atomically ionized by high-temperature plasma generated from a raw material gas such as argon gas supplied from the plasma gas tube.

The mass spectrometry unit 130 is provided with a vacuum chamber 131 having a configuration of a multi-stage differential exhaust system including a first vacuum chamber 141, a second vacuum chamber 142, and a third vacuum chamber 143, in which the degree of vacuum is increased stepwise from the side of the plasma torch 112. At the inlet of the first vacuum chamber 141, a sampling cone 144 is provided. A skimmer cone 145 is provided between the first vacuum chamber 141 and the second vacuum chamber 142. Arranged within the second vacuum chamber 142 are an ion lens 146 for focusing flight trajectories of ions and a collision cell 147 for removing interfering ions such as atomic ions, etc., by colliding with an inert gas such as a helium gas. Arranged within the third vacuum chamber 143 are a quadrupole mass filter 148 (a pre-rod and a main rod) and a detector 149. The atomic ions generated by the plasma torch 112 pass through the sampling cone 141 and the skimmer cone 145 to be aligned in the movement direction and is formed into a small-diameter ion beam, and is then mass-separated by the quadrupole mass filter 148 and detected by the detector 149.

The tip portion of the plasma torch 112 emits high-temperature plasma of 6,000 K to 10,000 K, and a part thereof travels along the outer peripheral surface of the sampling cone 144. Further, a part of the high-temperature plasma emitted to the sampling cone 144 passes through the opening formed at the tip portion of the sampling cone 144, enters the first vacuum chamber 141, and travels along the outer peripheral surface of the skimmer cone 145. Thus, since the sampling cone 144 and the skimmer cone 145 are entirely heated to a high temperature, the sampling cone 141 and the skimmer cone 145 are cooled by a method, such as, e.g., a method of attaching a cooling block through which cooling water flows to the base portion to prevent the melting.

### PRIOR ART DOCUMENT

### Patent Document

Patent Document 1: Japanese Unexamined Patent Application Publication No. 10-40857

### SUMMARY OF THE INVENTION

### Problems to be Solved by the Invention

A part of the plasma and sample that has passed through the sampling cone 144 adiabatically expands in a supersonic flow. Then, they further enter the second vacuum chamber 142 through the opening formed at the tip portion of the skimmer cone 145. The size of the opening formed at the tip portion of the sampling cone 144 is, for example, about 1.0 mm in diameter. The diameter of the opening formed at the tip portion of the skimmer cone 145 is, for example, about 0.5 mm. When the sample passes through the opening of the skimmer cone 145, a part of the sample is cooled by the skimmer cone 145 in the vicinity of the opening. With this, a part of the ionized sample is deionized and deposited on the surface of the skimmer cone 145 as a solid. In particular, when a highly concentrated sample is cooled, the amount of the deposition on the surface of the skimmer cone 145 increases in a shorter time. As a result, the opening formed at the tip portion of the skimmer cone 145 is blocked, which results in a significantly reduced introduction of ions into the mass spectrometry unit 130. For example, in the case of a sample prepared based on a solution obtained by diluting seawater, a large amount of sodium chloride or magnesium salt is deposited.

The object of the present invention sought to be solved is to prevent deposition of salts or the like in the vicinity of an opening formed at a tip portion of a skimmer cone in an inductively coupled plasma mass spectrometer.

### Means for Solving the Problem

A skimmer cone according to the present invention made to solve the above-described problems, incudes:

a groove formed on an outer peripheral surface and/or an inner peripheral surface of the skimmer cone in a circumferential direction.

The skimmer cone according to the present invention is intended to be used in an inductively coupled plasma mass spectrometer. The inductively coupled plasma mass spectrometer is provided with an ion source having a plasma torch for generating atomic ions from a sample by inductively coupled plasma and a mass separation unit for performing mass separation to detect the generated atomic ions. The ion source is provided in an atmospheric pressure space, and the mass separation unit is provided inside a vacuum chamber having a plurality of vacuum chambers partitioned by partitions and increased in the degree of vacuum stepwise toward the subsequent stage. Provided on the inlet side of the vacuum chamber is a sampling cone for shaping atomic ions produced by the ion source into a narrow diameter ion beam. The skimmer cone according to the present invention is provided to the partition located downstream of the sampling cone. The outer peripheral surface of the skimmer cone is irradiated with high-temperature plasma that has passed through the sampling cone. To prevent the melting of the skimmer cone due to the heat of the high-temperature plasma, the skimmer cone is cooled from the base portion side (partition side) by a cooling block through which cooling water flows. Alternatively, in some cases, it is cooled (air-cooled) by the atmosphere outside of the vacuum chamber via a partition. In both cases, the heat applied to the skimmer cone by the high-temperature plasma irradiation is transferred to the base portion side of the skimmer cone.

The skimmer cone according to the present invention is characterized in that a groove is formed on an outer peripheral surface and/or an inner peripheral surface of the skimmer cone in the circumferential direction. The groove may be formed around the entire periphery in the circumferential direction or may be partially formed around the periphery in the circumferential direction. Further, the number of the groove may be one or plural.

In the skimmer cone according to the present invention, since it becomes thin at the position of the groove formed on the outer peripheral surface and/or the inner peripheral surface, the path through which heat is transferred is narrowed (the cross-sectional area is reduced) at the position of the groove when the heat is transferred from the tip portion toward the base portion. Therefore, the heat on the tip portion side (the side opposite to the partition) with respect to the position where the groove is formed becomes less likely to be transferred to the base portion side. With this, the ions generated from the sample become less likely to be cooled in the vicinity of the opening formed at the tip portion of the sampling cone, so that it becomes possible to prevent deionization of the ions and deposition of salts or the like in the vicinity of the opening at the tip portion of the skimmer cone.

In the skimmer cone according to the present invention, the groove is preferably formed on the outer peripheral surface of the skimmer cone. The shape of the groove is not particularly limited, but the cross-section of the groove is preferably formed in an L-shape. When forming the groove in such a shape, the groove can be easily formed by processing using a milling machine or the like.

Further, the inductively coupled plasma mass spectrometer equipped with the skimmer cone according to the present invention, includes:

a) an ionization unit configured to ionize a sample by plasma generated from a raw material gas;

b) a vacuum chamber partitioned into a first space and a second space, the first space being maintained at a first pressure lower than atmospheric pressure, and the second space being maintained at a second pressure lower than the first pressure and configured to accommodate a mass separation unit for performing mass separation of ions generated by the ionization unit and a detector for detecting ions that have passed through the mass separation unit; and

c) a skimmer cone arranged on a side of the first space with respect to a partition partitioning the first space and the second space, the skimmer cone having a groove formed on an outer peripheral surface and/or an inner peripheral surface of the skimmer cone in a circumferential direction.

### Effects of the Invention

By using the skimmer cone according to the present invention in an inductively coupled plasma mass spectrometer, it is possible to prevent deposition of salts or the like in the vicinity of the opening formed at the tip portion of the skimmer cone.

### BRIEF DESCRIPTION OF THE DRAWINGS

FIG. 1 is a block diagram of a main part of an inductively coupled plasma mass spectrometer.

FIG. 2 is a block diagram of a main part of an example of an inductively coupled plasma mass spectrometer according to the present invention.

FIG. 3 is an enlarged view of a first vacuum chamber and its vicinity of the inductively coupled plasma mass spectrometer of the example.

FIG. 4 is an enlarged view of the tip portion of an example of a skimmer cone according to the present invention.

FIG. 5 is an enlarged view of a tip portion of a modification of a skimmer cone according to the present invention.

FIG. 6 is an enlarged view of a tip portion of another modification of a skimmer cone according to the present invention.

### EMBODIMENTS FOR CARRYING OUT THE INVENTION

Examples of a skimmer cone and an inductively coupled plasma mass spectrometer according to the present invention will be described below with reference to the attached drawings.

FIG. 2 is a configuration diagram of a main part of an inductively coupled plasma mass spectrometer 1 of this example. The inductively coupled plasma mass spectrometer 1 is roughly composed of an ionization unit 10, a mass spectrometry unit 20, a power supply unit 30, and a control unit 40.

The ionization unit 10 is provided with a grounded ionization chamber 11 at about atmospheric pressure, and a plasma torch 12 is arranged in the ionization chamber. The plasma torch 12 is composed of a sample tube for allowing a liquid sample atomized by a nebulizer gas to pass therethrough, a plasma gas tube formed on the outer periphery of the sample tube, and a cooling gas tube formed on the outer periphery of the plasma gas tube. The ionization unit is further provided with an auto-sampler 13 for introducing a liquid sample into the sample tube of the plasma torch 12, a nebulizer gas supply source 14 for supplying a nebulizer gas to the sample tube, a plasma gas supply source 15 for supplying a plasma gas (argon gas) to the plasma gas tube, and a cooling gas supply source (not shown) for supplying a cooling gas to the cooling gas tube.

The mass spectrometry unit 20 is provided with a first vacuum chamber 21, a second vacuum chamber 22, and a third vacuum chamber 24 in this order from the plasma torch 12. The first vacuum chamber 21 is an interface for the ionization chamber 11. The second vacuum chamber 22 is provided with an ion lens 221 for converging flight trajectories of ions and a collision cell 222. In the third vacuum chamber 24, a quadrupole mass filter 241 (a pre-rod 2411 and a main rod 2412) and a detector 242 are arranged. In this example, the vacuum chamber is composed of three vacuum chambers, but the number of vacuum chambers to be partitioned can be appropriately changed. The first vacuum chamber 21 in this example corresponds to the first space in the present invention, and the second vacuum chamber 22 and the third vacuum chamber 24 correspond to the second space in the present invention. A sampling cone 211 is provided on the inlet sidewall of the first vacuum chamber 21, and a skimmer cone 224 is provided on the partition between the first vacuum chamber 21 and the second vacuum chamber 22. In this example, the mass spectrometry unit 20 is provided with the quadrupole mass filter 241, but a mass separation unit other than a quadrupole mass filter can be used. Further, a plurality of mass separation units may be provided.

In addition to a storage unit 41, the control unit 40 is provided with an analysis control unit 42 as a functional block. The control unit 40 is actually composed of a personal computer, and the analysis control unit 42 is realized by executing a predetermined program (a program for mass spectrometry) by a CPU. An input unit 60, such as, e.g., a keyboard and a mouse, and a display unit 70, such as a liquid crystal display, are connected to the control unit 40. In the storage unit 41, the data of the output signals from the detector 242 are sequentially stored.

When the user instructs an analysis initiation via the input unit 60, a liquid sample is introduced into the sample tube of the plasma torch 12 by the auto-sampler 13. The liquid sample introduced into the sample tube is atomized by the nebulizer gas (e.g., nitrogen gas) supplied from the nebulizer gas supply source 14 and sprayed into the ionization chamber 11. In parallel with this, inductively coupled plasma is generated from a plasma gas (e.g., argon gas) supplied from the plasma gas supply source 15. The liquid sample sprayed from the sample tube is atomically ionized by the inductively coupled plasma. The high-temperature plasma gas of 6,000 K to 10,000 K generated by the plasma torch 12 of the ionization unit 10 travels along the outer peripheral surface of the sampling cone 211, thereby heating the entire sampling cone 211. A part of the plasma passes through an opening formed at the tip portion of the sampling cone 211 and travels along the outer peripheral surface of the skimmer cone 224, thereby heating the entire skimmer cone 224. As described above, since the sampling cone 211 and the skimmer cone 224 are heated to a high temperature, a cooling mechanism as described later is provided to cool them.

The atomic ions produced by the ionization unit 10 are introduced into the first vacuum chamber 21 in the vacuum chamber through the opening formed at the tip portion of the sampling cone 211. A part of the plasma and sample that has passed through the sampling cone 211 passes through the opening formed at the tip portion of the skimmer cone 224 and enters the second vacuum chamber 22 while being adiabatically expanded in a supersonic flow. As the sample passes through the opening of the skimmer cone 224, the sample passing near the opening is cooled by the skimmer cone 224. The diameter of the opening of the sampling cone 211 is typically about 1.0 mm. The diameter of the opening of the skimmer cone 224 is smaller than that of the opening of the sampling cone 211 (i.e., typically 1.0 mm or less), and is, for example, about 0.5 mm.

FIG. 3 shows the schematic configuration of the first vacuum chamber 21 and the vicinity thereof. As described above, the sampling cone 211 is provided at the inlet of the first vacuum chamber 21, and the skimmer cone 224 is provided between the first vacuum chamber 21 and the second vacuum chamber 22. Further, an L-shaped cooling block 212 is attached to the inner surface of the vacuum chamber 20a for accommodating the mass spectrometry unit 20. The portion of the cooling block 212 corresponding to the long side of the L-shape is attached to the inner wall surface of the vacuum chamber 20a, and one end thereof (the side opposite to the portion corresponding to the short side) is in contact with a base portion of the sampling cone 211. The base portion of the skimmer cone 224 is screwed to a portion of the cooling block corresponding to the short side of the L-shape, so that the skimmer cone 224 can be detachable. Inside the cooling block 212, a flow path for cooling water is formed so that the sampling cone 211 and the skimmer cone 224 are cooled by the cooling block 212. With this, the sampling cone 211 and the skimmer cone 224 are prevented from being melted by the high-temperature plasma generated by the plasma torch 12. Although in this example the sampling cone 211 and the skimmer cone 224 are cooled by the cooling block 212, the cooling method is arbitrarily configured. It is possible to adopt such a configuration that they are cooled (air-cooled) by the atmospheric air outside the vacuum chamber 20a via a partition. In either event, the heat applied to the skimmer cone 224 by the high-temperature plasma irradiation is transferred to the base portion of the skimmer cone 224. Although the skimmer cone 224 is detachable in this example, the skimmer cone 224 may be integrally configured with the partition between the first vacuum chamber 21 and the second vacuum chamber 22.

FIG. 4 is an enlarged view of the tip portion of the skimmer cone 224. As the skimmer cone 224, a skimmer cone made of copper or nickel is used. Further, in order to avoid contamination of contaminants at the time of the mass spectrometry, a skimmer cone made of a material having a high purity of 99% or more is used. Further, the skimmer cone 224 of this example is provided with three grooves 224a each formed in a circumferential direction on the outer peripheral surface of the tip portion. Each of the three grooves 224a is formed along the entire peripheral surface of the skimmer cone in the circumferential direction and has an L-shaped cross-section with a rounded corner. By forming the groove 224a in such a configuration, the groove 224a can be easily formed by processing using a milling machine or the like. The protrusion 224b formed between the groove 224a and the base portion of the skimmer cone 224 is provided so that an operation such as attaching and detaching the skimmer cone 224 can be performed without touching the tip portion. Note that the protrusion 224b is not an essential feature of the present invention, and a skimmer cone 224 having no protrusion 224b may be used.

The skimmer cone 224 of this example is characterized in that the groove 224a is formed along the entire outer peripheral surface of the skimmer cone 224 in the circumferential direction. With this, the thickness of the skimmer cone 224 becomes thinner at the position of the groove 224a, and therefore the path through which heat is transferred becomes narrow (the cross-section is reduced) at the position of the groove 224a as heat is transferred from the tip portion to the base portion. Therefore, the heat on the tip portion side (the side opposed to partition) with respect to the position where the groove 224a is formed becomes less likely to be transferred to the base portion side. Therefore, the sample becomes less likely to be cooled by the skimmer cone 224 when the sample passes through the vicinity of the opening of the skimmer cone 224. As a result, since the ionized sample becomes less likely to be deionized, it is possible to prevent deposition of salts or the like in the vicinity of the opening at the top portion of the skimmer cone 224. In the present invention, it is preferably configured such that at least one groove 224a be formed on the skimmer cone 224 at a position 5 mm or less from the tip portion side so that heat is held on the tip portion side with respect to the position of the groove 224a.

Conventionally, for example, as described in Patent Document 1, a skimmer is used in which the wall is formed to have a shape (knife-edge shape) that the cross-section becomes gradually thinner toward the tip portion side. In the skimmer cone of such a shape, by gradually narrowing the path through which heat is transferred toward the tip portion (reducing the cross-sectional area), since the tip portion at which an opening is formed is less likely to be cooled, there is a possibility that the effect of preventing deposition of salts or the like can be obtained. However, since the tip portion side is formed in a pointed shape, the tip portion is likely to be damaged or deformed when the tip portion comes into contact with other components or the like during the cleaning or replacement of the skimmer cone. Further, continuous irradiation of high-temperature plasma likely causes deformation of the tip portion. On the other hand, in the skimmer cone 224 of this example, since the required strength can be secure by appropriately adjusting the thickness of the tip portion, it is possible to suppress damage and deformation.

The above-described example is an example and can be arbitrarily modified in accordance with the spirit of the present invention. In the above-described example, on the outer peripheral surface of the skimmer cone 224, three grooves 224a each having an L-shaped cross-section are formed along the entire periphery, but the shape and the number of the groove 224a can be arbitrarily changed. The skimmer cone according to the present invention is based on the technical concept that, from the tip portion toward the base portion, at least one portion where the cross-sectional area is reduced (i.e., becomes thin) is provided so that the heat on the tip portion side (a side opposite to a partition) with respect to a position where the groove is formed becomes less likely to be transferred to the base portion side, and modifications can be arbitrarily made within the scope of the above-described technical scope.

FIG. 5 is an enlarged view of a tip portion of a skimmer cone 225 according to a modification. In the modification of FIG. 5, a groove 225a having an L-shaped cross-section is provided on the inner peripheral surface of the tip portion of the skimmer cone 225, similarly to the above-described example. FIG. 6 is an enlarged view of a tip portion of the skimmer cone 226 according to another modification. In the modification of FIG. 6, on both the inner peripheral surface of the skimmer cone 226 and the outer peripheral surface thereof, grooves 226a and 226b are partially formed in the circumferential direction. By using the skimmer cones 225 and 226 of the modifications as shown in FIG. 4 and FIG. 5, it is also possible to obtain the same effects as those of the above-described example. As the groove, in addition to those described above, various types of grooves, such as a groove having a V-shaped cross-section and a groove having a semicircular cross-section, can be used.

### DESCRIPTION OF SYMBOLS

1: Inductively coupled plasma mass spectrometer
10: Ionization unit
11: Ionization chamber
12: Plasma torch
13: Auto-sampler
14: Nebulizer gas supply source
15: Plasma gas supply source
20: Mass spectrometry unit
20a: Vacuum chamber
21: First vacuum chamber
211: Sampling cone
212: Cooling block
22: Second vacuum chamber
221: Ion lens
222: Collision cell
223: Energy barrier-forming electrode
224, 225, 226: Skimmer cone
224a, 225a, 226a: Groove
24: Third vacuum chamber
241: Quadrupole mass filter
2411: Pre-rod
2412: Main rod
242: Detector
30: Power supply unit
40: Control unit
41: Storage unit
42: Analysis control unit
60: Input unit
70: Display unit

1. A skimmer cone comprising:
a groove formed on an outer peripheral surface and/or an inner peripheral surface of at least a part of a conical tip portion of the skimmer cone in a circumferential direction.

2. The skimmer cone as recited in claim 1,
wherein the skimmer cone is made of nickel or copper having a purity of 99% or more.

3. The skimmer cone as recited in claim 1,
wherein a diameter of an opening formed at a tip portion of the skimmer cone is 1.0 mm or less.

4. The skimmer cone as recited in claim 1,
wherein the groove is formed on an outer peripheral side of the skimmer cone.

5. The skimmer cone as recited in claim 1,
wherein a cross-section of the groove is formed in an L-shape.

6. The skimmer cone as recited in claim 1,
wherein the groove is formed at a position within 5 mm from a tip portion of the skimmer cone.

7. The skimmer cone as recited in claim 1,
wherein a plurality of the grooves is formed.

8. An inductively coupled plasma mass spectrometer comprising:
a) an ionization unit configured to ionize a sample by plasma generated from a raw material gas;
b) a vacuum chamber partitioned into a first space and a second space, the first space being maintained at a first pressure lower than atmospheric pressure, and the second space being maintained at a second pressure lower than the first pressure and configured to accommodate a mass separation unit for performing mass separation of ions generated by the ionization unit and a detector for detecting ions that have passed through the mass separation unit; and
c) a skimmer cone arranged on a side of the first space with respect to a partition partitioning the first space and the second space, the skimmer cone having a groove formed on an outer peripheral surface and/or an inner peripheral surface of at least a part of a conical tip portion of a skimmer cone in a circumferential direction.
